(19) United States
(12) Patent Application Publication
(10) Pub. No.: US 2025/0144801 A1
(43) Pub. Date: May 8, 2025

(54) MANIPULATOR EXECUTION PATH PLANNING METHOD FOR COMPLEX SPACE GUIDED MEASUREMENT TASK

(71) Applicant: China Jiliang University, Hangzhou (CN)

(72) Inventors: Zai LUO, Hangzhou (CN); Wensong JIANG, Hangzhou (CN); Yan WANG, Hangzhou (CN); Li YANG, Hangzhou (CN); Minyue LI, Hangzhou (CN); Dian BIAN, Hangzhou (CN); Yaru LI, Hangzhou (CN)

(73) Assignee: China Jiliang University, Hangzhou (CN)

(21) Appl. No.: 19/018,106

(22) Filed: Jan. 13, 2025

(30) Foreign Application Priority Data
Aug. 23, 2024 (CN) 202411166504.0

(51) Int. Cl. B25J 9/16

(52) U.S. Cl. CPC B25J 9/1666; B25J 9/1602; B25J 9/163; B25J 9/1676

(57) ABSTRACT

A manipulator execution path planning method for a complex space guided measurement task, includes: determining a measurement space of a manipulator and a starting point and a target point of a path; determining an obstructed space and a free space of the measurement space and a proportion of the obstructed space in the measurement space using a collision algorithm, and classifying and constructing a space compression model according to the proportion of the obstructed space in the measurement space to compress the measurement space and remove an invalid space; finding candidate paths for connecting the starting point and the target point by constructing an adjacent node tree connected topology network; finding a required path in the candidate paths, and performing high-order curve fitting to obtain a final path; discretizing the final path, and solving joint angles of the manipulator to obtain a joint track.

### CROSS-REFERENCE TO RELATED APPLICATIONS

This application claims priority to Chinese Patent Application No. 202411158190.X with a filing date of Aug. 22, 2024. The content of the aforementioned application, including any intervening amendments thereto, is incorporated herein by reference.

### TECHNICAL FIELD

The present disclosure relates to the technical field of manipulator path planning, in particular to a manipulator execution path planning method for a complex space guided measurement task.

### BACKGROUND ART

In the field of manipulator path planning, mastering efficient and reliable motion planning is a cornerstone and prerequisite for a multi-degree-of-freedom robot to achieve motion intelligence, and is crucial in fields, such as industrial manufacturing defect detection, agriculturally harvestable crop investigation, UAV bridge structure inspection, minimally invasive surgery planning, and robot micromanipulation.

Existing technical motion planning methods mainly include a graph search method, an intelligent optimization method, and a sampling-based planning method. The graph search method is a method for efficiently searching a framework to traverse a working space and find an optimal solution and is suitable for two-dimensional space optimization, but its performance depends on a selected resolution, and its calculation cost is exponentially increased in a high-dimensional space. The intelligent optimization method, which is a learning-based approach, utilizes machine learning technology to solve optimization problems. It is particularly suitable for path planning in unknown environments, but faces challenges such as low convergence speed and high memory requirements. The sampling-based planning method is well-suited for high-degree-of-freedom problems, but faces challenges such as lack of directionality, non-uniform sampling, and non-smooth paths.

Therefore, a manipulator execution path planning method for a complex space guided measurement task is urgently needed to increase the manipulator path planning efficiency and improve the quality of a path.

### SUMMARY OF THE INVENTION

In order to solve the above-mentioned technical problems, the present disclosure provides a manipulator execution path planning method for a complex space guided measurement task, by which the manipulator path planning efficiency can be increased, and the quality of a path can be improved.

The present disclosure provides a manipulator execution path planning method for a complex space guided measurement task, including the following steps that:

S1, determining a measurement space Ω of a manipulator;

S2, determining a starting point and a target point of a manipulator path;

S3, by means of a collision algorithm, determining an obstructed space Ω₀ and a free space Ω_{f} of the measurement space Ω; and determining a proportion of the obstructed space in the measurement space; wherein a calculation formula for the proportion is expressed as:

$$λ = {Ω}_{0} / Ω ,$$

$$λϵ ( 0 , 1 ] ;$$

S4, constructing a space compression model to compress the measurement space and remove an invalid space in the measurement space; wherein S4 specifically includes: when >>0.5, constructing a first model to compress the measurement space; and when A≤0.5, constructing a hyper-ellipsoidal model to compress the measurement space;

S5, in the compressed measurement space Ωₙ,finding candidate paths for connecting the starting point and the target point by constructing an adjacent node tree connected topology network according to a preset iterative step length;

S6, establishing a reinforcement learning drive model for the candidate path dataset, and finding a required path by utilizing a target equation with the shortest path and time;

S7, performing high-order curve fitting on the required path to achieve the smoothing of the required path and obtain a final path;

S8, discretizing the final path obtained in step S7, solving and calculating joint angles of the manipulator by using an inverse kinematics algorithm, and determining an angle of each joint of the manipulator to obtain a joint path of each joint moving in a space; and

S9, calculating whether interference exists between each joint path and the obstructed space, when the interference exists between a joint path and the obstructed space, adjusting parameters of the space compression model, and returning to S4 to be re-performed; and when no interference exists between any joint path and the obstructed space, completing path control from the starting point to the target point on the manipulator according to the joint path of each joint moving in the space in S8.

Further, the first model is expressed as:

$$\{ \begin{matrix}x = {k}_{1} \cdot t \\ y = {k}_{2} \cdot [ ( x - {k}_{3} ) + {k}_{4} ] + t \cdot ε\end{matrix}$$

$$or$$

$$\{ \begin{matrix}x = {k}_{1} \cdot t \\ y = {k}_{2} \cdot [ ( x - {k}_{3} ) + {k}_{4} ] + 2 \cdot t \cdot ε \\ z = {k}_{5} \cdot [ ( x - {k}_{3} ) + {k}_{6} ] + 2 \cdot t \cdot ε\end{matrix} ;$$

wherein k₁ is a boundary value of the measurement space, and k₁=maxΩ−minΩ; k₂, k₃, k₄, k₅ and k₆ are constants related to the starting point and the target point; t∈(0,1) is a random number conforming to uniform distribution; ε is a compression constant, and ε=γλ, wherein γ is a constant.

Further, the hyper-ellipsoidal model is expressed as:

$$F ( x , y , z ) = \frac{{( x - {x}_{0} )}^{2}}{{a}_{0}^{2}} + \frac{{( y - {y}_{0} )}^{2}}{{a}_{1}^{2}} + \frac{{( z - {z}_{0} )}^{2}}{{a}_{2}^{2}} - 1 ;$$

wherein a₀ is a long axis, a₀=∥xᵢ−x_{g}∥₂; xᵢ is the starting point; x_{g} is the target point; a₁ is a medial axis,

$${a}_{1} = \frac{\sqrt[2]{{c ( t )}^{2} - {a}_{0}^{2}}}{2} ;$$

a₂ is a short axis, c(t)

$${a}_{2} = \frac{\sqrt[2]{{c ( t )}^{2} - {a}_{0}^{2}}}{4} ;$$

is a path length obtained last time; and (x₀, y₀, z₀) is coordinates of the starting point.

Further, S5 specifically includes:

S51, presetting an iterative step length δ, that is, expanding nodes for a distance δ every time during search;

S52, starting from the starting point, initializing a first node;

S53, searching a new node around the current node according to the preset iterative step length δ; and

S54, connecting the new node to the current node to construct the adjacent node tree connected topology network.

Further, S51 further includes:

presetting a threshold φ, wherein when a distance from the new node to the target point is smaller than or equal to the threshold φ, the target point is considered to be reached, and a cycle step is no longer performed; and a search range is the compressed measurement space Ωₙ.

Further, S53 specifically includes:

S531, supposing that the current node is xₙ(t);

S532, respectively calculating Euclidean distances from all the nodes in the adjacent node tree connected topology network to the current node xₙ(t), selecting the closest node as the closest point x_{f}(t), and backwards extending a new node from x_{f}(t);

S533, determining a new node xₙ(t+1) by calculation, wherein a formula is expressed as:

$${x}_{n} ( t + 1 ) = {x}_{n} ( t ) + δ \cdot \frac{{x}_{r} ( t ) - {x}_{f} ( t )}{\vert {x}_{r} ( t ) - {x}_{f} ( t ) \vert} + \frac{{x}_{g} ( t ) - {x}_{r} ( t )}{\vert {x}_{g} ( t ) - {x}_{r} ( t ) \vert} ;$$

wherein xᵣ(t) is a preselected point possible to become the next node; and

S534, repeating above steps to determine whether a distance from the new node xₙ(t+1) to the target point is smaller than the threshold φ, if so, stopping the repetition; and if not, further performing steps S431 to S434.

Further, S7 specifically includes:

S71, selecting a type and an order of a high-order curve according to complexity, curvature change and smoothness requirements of the required path;

S72, taking a key point or node of the required path as a control point for the high-order curve fitting; and

S73, performing the high-order curve fitting by using the selected type and order of the high-order curve and the control point to generate a curve representing a smoothed path of the required path, i.e., the final path.

Further, S8 specifically includes:

S81, initializing structural parameters of the manipulator, wherein the structural parameters include a linkage length, linkage torsion, linkage offset, and the joint angles;

S82, discretizing the final path to form discrete point sequences, wherein the discrete point sequences are taken as path points of motion of the manipulator;

S83, calculating, by using the inverse kinematics algorithm according to the structural parameters and the path points of the manipulator, an angle value required to be reached by each joint, corresponding to each path point, of the manipulator; and

S84, generating a track of change of the angle of each joint of the manipulator with time, i.e., a motion process of the manipulator from the starting point to a target position, according to a result solved by using the inverse kinematics algorithm.

The embodiments of the present disclosure have the following technical effects:
1. by constructing and applying the space compression model, removing the invalid space and simplifying search for the invalid space, the complexity of path search and the calculated amount are effectively reduced, and the path planning efficiency is increased.
2. By constructing the adjacent node tree connected topology network according to the preset iterative step length and sampling a planning method with the target point as a guide, the convergence speed is increased, and areas where solutions are located can be rapidly found in the compressed measurement space, so that sampling nonuniformity is solved, and the path planning efficiency is increased.
3. By introducing a reinforcement learning method, a solution domain is traversed to achieve the local adjustment of the path and complementation with the path planning method, and the best or second best solution of the path is found while the convergence speed is increased, so that demands are met.
4. Smoothing at a path corner is achieved in conjunction with Bezier curve fitting, so that the outputted path has good smoothness and few turning points.

### BRIEF DESCRIPTION OF THE DRAWINGS

In order to describe technical solutions in specific implementations of the present disclosure or the prior art more clearly, the accompanying drawings required for describing the specific implementations or the prior art will be briefly introduced below. Apparently, the accompanying drawings in the following description show only some implementations of the present disclosure, and those of ordinary skill in the art can still derive other accompanying drawings from these accompanying drawings without creative efforts.

FIG. 1 is a process diagram of a manipulator execution path planning method for a complex space guided measurement task provided in an embodiment of the present disclosure;

FIG. 2 is a schematic diagram of a geometrical relationship for path smoothness provided in an embodiment of the present disclosure; and

FIG. 3 is a robot measurement system provided in an embodiment of the present disclosure.

### DETAILED DESCRIPTION OF THE INVENTION

In order to make objects, technical solutions and advantages of the present disclosure clearer, the technical solutions in the present disclosure will be described clearly and completely below. Obviously, the described embodiments are a part of the embodiments of the present disclosure, not all the embodiments. Based on the embodiments of the present disclosure, all other embodiments obtained by those of ordinary skill in the art without creative efforts shall fall within the protective scope of the present disclosure.

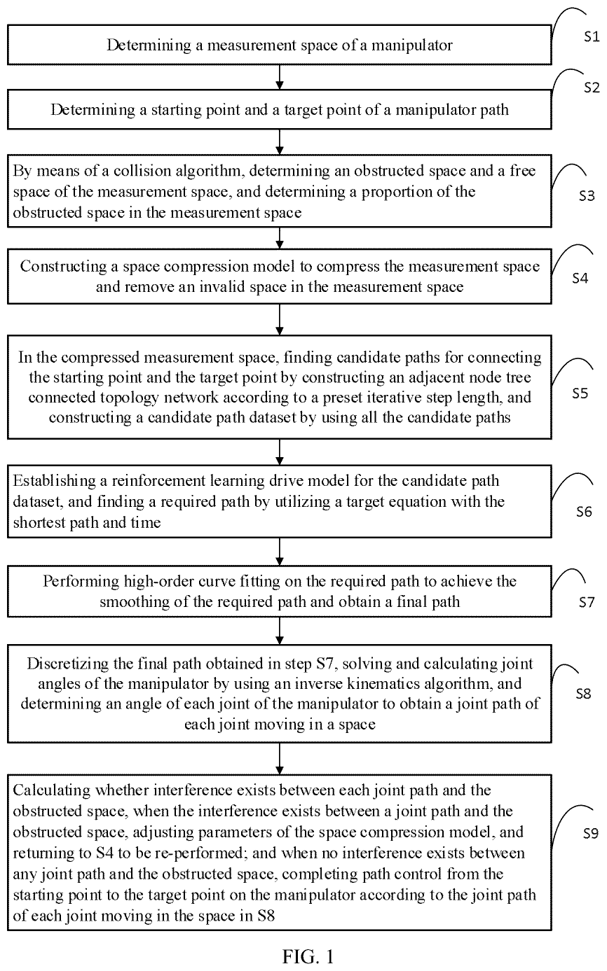

FIG. 1 is a process diagram of a manipulator execution path planning method for a complex space guided measurement task provided in an embodiment of the present disclosure. Refer to FIG. 1, the manipulator execution path planning method specifically includes:

S1, a measurement space Ω of a manipulator is determined;

Optionally, multi-dimensional information of a measurement environment is acquired by using a three-dimensional laser point cloud scanning technology, a measurement scenario is restored according to a three-dimensional reconstruction algorithm, the measurement space Ω of the manipulator is determined and is transmitted to a control end for path planning for a measurement task.

S2, a starting point and a target point of a manipulator path are determined;

Specifically, an initial position where the manipulator begins to execute the task in the measurement space and a final position where the manipulator is required to reach to execute the task are determined according to a specific task demand.

S3, by means of a collision algorithm, an obstructed space Ω₀ and a free space Ω_{f} of the measurement space Ω are determined; and a proportion of the obstructed space in the measurement space is determined; a calculation formula for the proportion is expressed as:

$$λ = {Ω}_{0} / Ω ,$$

$$λϵ ( 0 , 1 ] ;$$

by means of the proportion λ of the obstructed space in the measurement space, the complexity of the measurement space and influences of the measurement space on the difficulty level of the planning path are balanced.

S4, a space compression model is constructed to compress the measurement space and remove an invalid space in the measurement space; S4 specifically includes: when λ>0.5, a first model is constructed to compress the measurement space; and when λ≤0.5, a hyper-ellipsoidal model is constructed to compress the measurement space.

Improper space compression will hinder the finding of the path, and the problem will evolve into more complex narrow space path search. Therefore, by setting a threshold of the complexity of the measurement space, the space compression model is constructed according to two situations, and corresponding space compression models are selected according to different measurement spaces to perform space compression; when λ>0.5, it indicates that the measurement space is not only full of complex three-dimensional structures, but also is interspersed with narrow and fully-obstructed channel environments, and the first model is selected to compress the space; and when λ≤0.5, it indicates that there is a lower obstacle density in the measurement space, and the hyper-ellipsoidal model is selected to compress the space.

Further, the first model is expressed as:

$$\{ \begin{matrix}x = {k}_{1} \cdot t \\ y = {k}_{2} \cdot [ ( x - {k}_{3} ) + {k}_{4} ] + t \cdot ε\end{matrix}$$

$$or$$

$$\{ \begin{matrix}x = {k}_{1} \cdot t \\ y = {k}_{2} \cdot [ ( x - {k}_{3} ) + {k}_{4} ] + 2 \cdot t \cdot ε \\ z = {k}_{5} \cdot [ ( x - {k}_{3} ) + {k}_{6} ] + 2 \cdot t \cdot ε\end{matrix} ;$$

wherein k₁ is a boundary value of the measurement space, and k₁=maxΩ−minΩ; k₂, k₃, k₄, k₅ and k₆ are constants related to the starting point and the target point; t∈(0,1) is a random number conforming to uniform distribution; ε is a compression constant, and ε=γλ, wherein γ is a constant.

Further, the hyper-ellipsoidal model is expressed as:

$$F ( x , y , z ) = \frac{{( x - {x}_{0} )}^{2}}{{a}_{0}^{2}} + \frac{{( y - {y}_{0} )}^{2}}{{a}_{1}^{2}} + \frac{{( z - {z}_{0} )}^{2}}{{a}_{2}^{2}} - 1 ;$$

wherein a₀ is a long axis, a₀=∥xᵢ−x_{g}∥₂; xᵢ is the starting point; x_{g} is the target point; a₁ is a medial axis,

$${a}_{1} = \frac{\sqrt[2]{{c ( t )}^{2} - {a}_{0}^{2}}}{2} ;$$

a₂ is a short axis,

$${a}_{2} = \frac{\sqrt[2]{{c ( t )}^{2} - {a}_{0}^{2}}}{4} ;$$

c(t) is a path length obtained last time; and (x₀, y₀, z₀) is coordinates of the starting point;

Specifically, when the hyper-ellipsoidal model is utilized to achieve space compression, lengths of the long axis (a₀), the medial axis (a₁) and the short axis (a₂) are not constant, but are dynamically adjusted according to the path length c(t) obtained last time. Such adjustment ensures that a search space can be gradually reduced with a search process, and thus, the search efficiency is increased.

An implementation way that the hyper-ellipsoidal model is utilized for space compression is that:

ellipsoid adjustment based on a path length: by means of iterative cycle, an axial length parameter of an ellipsoid is updated in each iteration according to a path length obtained last time, when the path length is reduced, it means that there is a better path in the search space, and therefore, the range of the ellipsoid will be correspondingly reduced a potential optimal path is surrounded by the ellipsoid more closely.

$$c ( t ) = arg {min}_{t} \{ {\sum }_{j = 1}^{m} {‖ {x}_{j + 1} - {x}_{j} ‖}_{2} + {\sum }_{i = 1}^{n} {‖ {θ}_{i} ( t + 1 ) - {θ}_{i} ( t ) ‖}_{2} \} ;$$

wherein xⱼ, xⱼ₊₁∈ξ₀, ξ₀is an initial path meeting environment constraints and task constraints, xⱼ and xⱼ₊₁ are two adjacent points on the initial path, θ is a certain joint angle of the manipulator, and n is the number of joints, i.e., the degree of freedom of the manipulator.

An expression of a hyper-ellipsoidal model in a three-dimensional space is projected to an xy plane, by which an expression of a two-dimensional space can be obtained. Such a projection not only simplifies a problem, but also makes path search on the two-dimensional plane possible; at the same time, by means of projection, the range of the search space can be further limited to achieve space compression.

In order to enable a hyper-ellipsoid to cover starting and ending point positions and to meet a search demand in a high-dimensional environment, the position and posture of the ellipsoid can be adjusted by rotation and translation operations during algorithm execution, and these operations ensure that the ellipsoid can adapt to the change of the search space more flexibly, so that the search efficiency is further increased.

Optionally, when a rotation axis and a rotation angle are given, a rotation matrix is obtained according to a Rodrigues's Formula:

$$R = [ \begin{matrix}{n}_{x}^{2} + ( 1 - {n}_{x}^{2} ) cos β & \begin{matrix}{n}_{x} {n}_{y} ( 1 - cos β ) - \\ {n}_{z} sin β\end{matrix} & \begin{matrix}{n}_{x} {n}_{z} ( 1 - cos β ) + \\ {n}_{y} sin β\end{matrix} \\ \begin{matrix}{n}_{x} {n}_{y} ( 1 - cos β ) + \\ {n}_{z} sin β\end{matrix} & {n}_{y}^{2} + ( 1 - {n}_{y}^{2} ) cos β & \begin{matrix}{n}_{y} {n}_{z} ( 1 - cos β ) - \\ {n}_{x} sin β\end{matrix} \\ \begin{matrix}{n}_{x} {n}_{z} ( 1 - cos β ) - \\ {n}_{y} sin β\end{matrix} & \begin{matrix}{n}_{y} {n}_{z} ( 1 - cos β ) + \\ {n}_{x} sin β\end{matrix} & {n}_{z}^{2} + ( 1 - {n}_{z}^{2} ) cos β\end{matrix} ] ;$$

### Wherein

$$n = \frac{U \hat{} V}{{‖ U \hat{} V ‖}_{2}} = [ \begin{matrix}{n}_{x} \\ {n}_{y} \\ {n}_{z}\end{matrix} ] ,$$

u and v respectively represent vectors from an origin of a coordinate axis to a central point and a starting point in the ellipsoid, and

$$β = arc cos ( {\sum }_{i = 1}^{3} {f}_{i} ( u ) \times {f}_{i} ( v ) , f ( x ) = \frac{x}{‖ x ‖} ) .$$

S5, in the compressed measurement space (Ωₙ, candidate paths for connecting the starting point and the target point are found by constructing an adjacent node tree connected topology network according to a preset iterative step length, and a candidate path dataset is constructed by using all the candidate paths, which specifically includes:

S51, an iterative step length δ is preset, that is, nodes are expanded for a distance δ every time during search;

S51 further includes: a threshold φ is preset, wherein when a distance from a new node to the target point is smaller than or equal to the threshold φ, the target point is considered to be reached, and a cycle step is no longer performed; and a search range is the compressed measurement space Ωₙ.

S52, starting from the starting point, a first node is initialized;

S53, a new node is searched around the current node according to the preset iterative step length δ, which specifically includes:

S531, it is supposed that the current node is xₙ(t);

S532, Euclidean distances from all the nodes in the adjacent node tree connected topology network to a random point xₙ(t) are respectively calculated, the closest node is selected as the closest point x_{f}(t), and a new node is backwards extended from x_{f}(t);

S533, a new node xₙ(t+1) is determined by calculation, wherein a formula is expressed as:

$${x}_{n} ( t + 1 ) = {x}_{n} ( t ) + δ \cdot \frac{{x}_{r} ( t ) - {x}_{f} ( t )}{\vert {x}_{r} ( t ) - {x}_{f} ( t ) \vert} + \frac{{x}_{g} ( t ) - {x}_{r} ( t )}{\vert {x}_{g} ( t ) - {x}_{r} ( t ) \vert} ;$$

wherein xᵣ(t) is a preselected point possible to become the next node; and

S534, above steps are repeated to determine whether a distance from the new node xₙ(t+1) to the target point is smaller than the threshold φ, if so, the repetition is stopped; and if not, steps S431 to S434 are further performed.

S54, the new node is connected to the current node to construct the adjacent node tree connected topology network.

S6, a reinforcement learning drive model is established for the candidate path dataset, and a required path is found by utilizing a target equation with the shortest path and time;

preferably, when a reinforcement learning algorithm is selected, the required path can be found in the candidate paths by means of a Q-learning reinforcement learning method, which specifically includes:

S61, a Q table is initialized, and the number of iterations is set;

S62, an environment and a state of an intelligent agent are determined;

S63, an action is selected, that is, an action a is selected in the current state s according to a ε-greedy strategy;

S64, a reward function is designed so that the intelligent agent can tend to select a path with the shortest distance or time, wherein the reward function can be set as a negative value of the path length or a negative value of time consumption, so that the intelligent agent minimizes these indicators during learning;

S65, the action is performed, and a reward is observed, that is, the selected action a is performed, and a reward R returned by an environment and a new state s′ are observed;

S66, Q values in the Q table are updated by using a Q-learning updating formula, wherein the Q-learning updating formula is expressed as: Q(s, a)=Q(s, a)+α·(R+σ·maxQ(s′, a′)−Q(s, a)), wherein Q(s,a) represents a Q value of the action a taken in the state s, α is a learning rate, R is an observed reward, σ is a discount factor, s′ is the next state, and a′ is the optimal action in the next state; and

S67, the state is updated as the new state s′, and step S53 to step S55 are repeated until the number of iterations is reached.

S7, high-order curve fitting is performed on the required path to achieve the smoothing of the required path and obtain a final path, which specifically includes:

S71, a type and an order of a high-order curve are selected according to complexity, curvature change and smoothness requirements of the required path;

S72, a key point or node of the required path is taken as a control point for the high-order curve fitting; and

S73, the high-order curve fitting is performed by using the selected type and order of the high-order curve and the control point to generate a curve representing a smoothed path of the required path, i.e., the final path.

Preferably, the required path is fitted by using a Bezier curve to achieve the smoothing of the required path and obtain a final path, which specifically includes:

by using the above-mentioned path planning method, a group of valid nodes from the starting point position to the target point can be found in the measurement space, a path generated by connecting these nodes consisting of a plurality of linear segments, and after a manipulator joint model is introduced, the segmental planned path also needs to be further smoothed so as to meet corner constraints of the manipulator under a polar coordinate system. A curve fitting method can reduce the change of the direction and shape of the initial path, and can reach constraints to which a curvature conforms without breaking existing constraints.

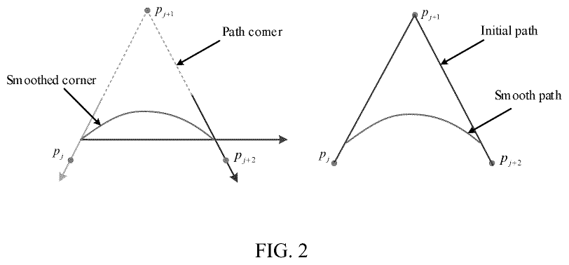

FIG. 2 is a schematic diagram of a geometrical relationship for path smoothness provided in an embodiment of the present disclosure. As shown in FIG. 2, given are P₀, P₁, . . . , Pₑ, and a formula of the Bezier curve thereof is expressed as:

$$B ( τ ) = {\sum }_{b = 0}^{e} ( \begin{matrix}e \\ b\end{matrix} ) {{p}_{b} ( 1 - τ )}^{e - b} {τ}^{b} = ( \begin{matrix}e \\ 0\end{matrix} ) {{p}_{0} ( 1 - τ )}^{e} {τ}^{0} + ( \begin{matrix}e \\ 1\end{matrix} ) {{p}_{1} ( 1 - τ )}^{e - 1} {τ}^{1} + … + ( \begin{matrix}e \\ e - 1\end{matrix} ) {{p}_{e - 1} ( 1 - τ )}^{1} {τ}^{e - 1} + ( \begin{matrix}e \\ e\end{matrix} ) {{p}_{e} ( 1 - τ )}^{0} {τ}^{e} ,$$

$$τ ∈ [ 0 , 1 ] ;$$

wherein τ is a parameter, a numerical value thereof varies between 0 and 1 and is used for affirming a position on the curve.

A curve is fitted between p₀ and p₂, a curvature of a path is designed by using a control point p₁, that is, a formula is expressed as:

$$B ( τ ) = {( 1 - τ )}^{2} {p}_{0} + 2 τ ( 1 - τ ) {p}_{1} + {τ}^{2} {p}_{2} ,$$

$$τ ∈ [ 0 , 1 ] ;$$

a smoothed equation (a straight line and a curve which are characterized with time as an independent variable) is divided into two linear combinations of a spatial straight line and a fitting curve, and refer to a two-dimensional planar straight line parameter equation expression, the spatial straight line can be expressed as:

$$x = {x}_{0} + μ cos η$$

$$y = {y}_{0} + μ sin η ;$$

$$z = {z}_{0} + μ ς$$

wherein (x₀, y₀, z₀) represents a starting point of a spatial line segment in a coordinate system, μ is a distance from one end to the other end of a line segment, η represents an included angle, with degree as a unit, of a straight line and an x axis in an xy coordinate system, and [symbol] represents a ratio of a projection of the straight line on a z axis to a projection of the straight line on an xy plane.

S8, the final path obtained in step S7 is discretized, joint angles of the manipulator are solved and calculated by using an inverse kinematics algorithm, an angle of each joint of the manipulator is determined to finally obtain a joint track of the joint moving in the space, i.e., a joint path of each joint moving in a space, which specifically includes:

S81, structural parameters of the manipulator are initialized, wherein the structural parameters include a linkage length, linkage torsion, linkage offset, and the joint angles;

S82, the final path is discretized to form discrete point sequences, wherein the discrete point sequences are taken as path points of motion of the manipulator;

S83, an angle value required to be reached by each joint, corresponding to each path point, of the manipulator is calculated by using the inverse kinematics algorithm according to the structural parameters and the path points of the manipulator;

a relative position and posture relationship between a robot and each of other multi-linkage mechanisms is described by using an MD-H method, i.e., a Modified Denavit-Hartenberg method. These transformation matrices are calculated on the basis of MD-H parameters, and these parameters include a linkage length, linkage torsion, linkage offset, and the joint angles. By combining these transformation matrices, a total transformation matrix from a base coordinate system to an end executor coordinate system can be obtained, and thus, the entire position and posture of the robot at given joint angles are described; and

S84, a track of change of the angle of each joint of the manipulator with time, i.e., a motion process of the manipulator from the starting point to a target position, is generated according to a result solved by using the inverse kinematics algorithm.

S9, it is calculated whether interference exists between each joint path and the obstructed space, when the interference exists between a joint path and the obstructed space, parameters of the space compression model are adjusted, and S4 is returned to be re-performed; and when no interference exists between any joint path and the obstructed space, path control from the starting point to the target point on the manipulator is completed according to the joint path of each joint moving in the space in S8.

S9 specifically includes: it is calculated whether interference exists between each joint path and the obstructed space, wherein a calculation method is described as follows:

with any two adjacent points on the joint path being denoted by q₁ and q₂ and an obstacle being enveloped by a box body [cxₘᵢₙ, cxₘₐₓ, cyₘᵢₙ, cyₘₐₓ] (boundary value), collision detection is performed, that is, line-plane intersection is determined; and each point on the path is detected by discretizing the joint path to determine the interference between the joint path and the obstacle.

Discretization stepping is represented by using a parameter sigma; and a detection point q is calculated according to the parameter sigma, wherein a position of the detection point q can be expressed as q=singma×q₁+(1-singma)×q₂;

it is determined whether the point q is located in the obstructed space: coordinates of q, i.e., q (qₓ, q_{y}, q_{z}), are determined; and m is set as a safe distance and is used for determining there is a sufficient distance between the joint path and the obstacle to avoid collision, that is, it is considered that interference exists between the joint path and the obstacle within the distance.

If pₓ>=cxₘᵢₙ, pₓ <=cxₘₐₓ+u, p_{y}>=cyₘᵢₙ, p_{y}<=cyₘₐₓ+u, p_{z}>=czₘᵢₙ, and p_{z} <=czₘₐₓ+u), wherein u represents the safe distance, it is determined that the interference exists between each joint path and the obstructed space, or else, it is determined that the interference does not exist between each joint path and the obstructed space.

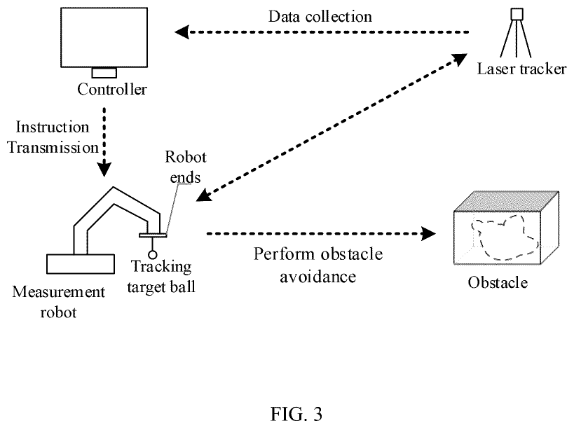

In order to describe the application advantages of the path planning method provided in the present disclosure, a robot measurement system is designed. As shown in FIG. 3, the robot measurement system consists of a measurement robot, an obstacle environment controller, a target ball, and a laser tracker, wherein an effective working radius of the selected robot is 815 mm, and a joint range thereof can rotate for ±360 degrees; the obstacle environment controller is formed by combining a plurality of rectangles; and the laser tracker is an FARO Vantage laser tracker. An experiment process is described as follows: a simulation environment is established in an MATLAB, and a copy of a scale model is constructed according to map setting of the measurement space to perform precise measurement. A measurement result is shown in table 1:

TABLE 1
Measurement Result

| | |
|---|---|
| Nominal value (mm) | Measured value (mm) |

| um | x | y | z | x | y | z |
|---|---|---|---|---|---|---|
| 1 | 5.00 | 5.00 | 5.00 | 4.62 | 3.06 | 5.31 |
| 2 | 14.49 | 17.28 | 8.84 | 12.80 | 14.91 | 10.85 |
| 3 | 23.96 | 29.56 | 12.67 | 21.19 | 27.88 | 14.33 |
| 4 | 33.42 | 41.85 | 16.48 | 31.73 | 39.22 | 17.72 |
| 5 | 42.86 | 54.15 | 20.26 | 42.08 | 51.88 | 21.11 |
| 6 | 52.23 | 66.50 | 23.95 | 52.10 | 64.76 | 24.49 |
| 7 | 58.35 | 75.23 | 26.02 | 58.53 | 73.91 | 26.37 |
| 8 | 72.99 | 79.42 | 22.49 | 73.14 | 78.47 | 22.86 |
| 9 | 87.27 | 83.37 | 18.46 | 87.34 | 82.75 | 18.81 |
| 10 | 95.81 | 79.98 | 31.30 | 95.57 | 79.64 | 31.74 |
| 11 | 85.45 | 88.62 | 47.92 | 85.31 | 88.48 | 48.88 |
| 12 | 95.00 | 95.00 | 55.00 | 94.76 | 95.35 | 55.08 |

By introducing the first model and the hyper-ellipsoidal model, the measurement space for path planning is redivided, so that the blindness of sample search is lowered, the consistency of path planning solutions is improved, and the quality standard deviation of the obtained path is improved by 59.63%. At the same time, the formula of the new node xₙ(t+1) provides a sampling way for a regiven new path point and improves the target guidance, and compared with traditional RRT, an average length of a planned path is reduced by 29.59%, and sampling points are reduced by 88.36%. Therefore, it can be seen that the path planning method provided in the present disclosure solves the problems of blindness, low efficiency and poor solution consistency of path search performed by the manipulator in a complex environment.

It should be noted that terms used in the present disclosure are only intended to describe specific embodiments, rather than to limit a scope of the present disclosure. As shown in the description of the present disclosure, words such as “an”, “one”, “a” and/or “the” do not refer in particular to a singular number, and can also be a plural number unless exceptional situations are clearly prompted in contexts. Terms “include”, “including” or any variants thereof are intended to cover non-exclusive inclusion, so that a process, method or device including a series of elements not only includes those elements, but also includes other elements not listed clearly, or further includes inherent elements of the process, method or device. In a case that there are no more limitations, elements defined by the word “including a . . . ” do not exclude other same elements further existing in the process, method or device including the elements.

It should be further noted that directional or positional relationships indicated by terms such as “center”, “upper”, “lower”, “left”, “right”, “vertical”, “horizontal”, “inner” and “outer” are based on directional or positional relationships as shown in the accompanying drawings, and are only for the purposes of facilitating describing the present disclosure and simplifying the description, rather than indicating or implying that the referred apparatus or clement has to have a specific direction or be constructed and operated in the specific direction, and therefore, they cannot be regarded as limitations on the present disclosure. Unless clearly specified and defined otherwise, terms such as “mounted”, “connected” and “connection” should be understood in a broad sense, for example, “connection” can be fixed connection or detachable connection or integral connection, can be mechanical connection or electrical connection, can be direct connection or indirect connection through an intermediate medium, and can be internal connection of two elements. For those of ordinary skill in the art, specific meanings of the above-mentioned terms in the present disclosure can be understood according to specific situations.

Finally, it should be noted that the above-mentioned embodiments are only intended to describe the technical solutions of the present disclosure, rather than to limit the technical solutions of the present disclosure; although the present disclosure has been described in detail with reference to the aforementioned embodiments, it should be understood by those of ordinary skill in the art that they can still modify the technical solutions recorded in each of the aforementioned embodiments or equivalently substitute parts or all of technical features therein; and these modifications or substitutions do not make the essences of the corresponding technical solutions depart from the technical solutions of the embodiments of the present disclosure.

What is claimed is:

1. A manipulator execution path planning method for a complex space guided measurement task, comprising the following steps:
S1, determining a measurement space Ω of a manipulator;
S2, determining a starting point and a target point of a manipulator path;
S3, using a collision algorithm, determining an obstructed space Ω₀ and a free space Ω_{f} of the measurement space Ω; and determining a proportion of the obstructed space in the measurement space; wherein a calculation formula for the proportion is expressed as:
$$λ = {Ω}_{0} / Ω ,$$
$$λϵ ( 0 , 1 ] ;$$
S4, constructing a space compression model to compress the measurement space and remove an invalid space in the measurement space; wherein S4 specifically comprises: when λ>0.5, constructing a first model to compress the measurement space; and when λ≤0.5, constructing a hyper-ellipsoidal model to compress the measurement space; wherein the first model is expressed as:
$$\{ \begin{matrix}x = {k}_{1} \cdot t \\ y = {k}_{2} \cdot [ ( x - {k}_{3} ) + {k}_{4} ] + t \cdot ε\end{matrix}$$
$$or$$
$$\{ \begin{matrix}x = {k}_{1} \cdot t \\ y = {k}_{2} \cdot [ ( x - {k}_{3} ) + {k}_{4} ] + 2 \cdot t \cdot ε \\ z = {k}_{5} \cdot [ ( x - {k}_{3} ) + {k}_{6} ] + 2 \cdot t \cdot ε\end{matrix} ;$$
wherein k₁ is a boundary value of the measurement space, and k₁=maxΩ−minΩ; k₂, k₃, k₄, k₅ and k₆ are constants related to the starting point and the target point; t∈(0,1) is a random number conforming to uniform distribution; ε is a compression constant, and ε=γλ, wherein γ is a constant;
the hyper-ellipsoidal model is expressed as:
$$F ( x , y , z ) = \frac{{( x - {x}_{0} )}^{2}}{{a}_{0}^{2}} + \frac{{( y - {y}_{0} )}^{2}}{{a}_{1}^{2}} + \frac{{( z - {z}_{0} )}^{2}}{{a}_{2}^{2}} - 1 ;$$
wherein a₀ is a long axis, a₀=∥xᵢ−x_{g}∥; xᵢ is the starting point; x_{g} is the target point; a₁ is a medial axis,
$${a}_{1} = \frac{\sqrt[2]{{c ( t )}^{2} - {a}_{0}^{2}}}{2} ;$$
a₂ is a short axis,
$${a}_{2} = \frac{\sqrt[2]{{c ( t )}^{2} - {a}_{0}^{2}}}{4} ;$$
c(t) is a path length obtained last time; and (x₀, y₀, z₀) is coordinates of the starting point;
S5, in the compressed measurement space Ωₙ, finding candidate paths for connecting the starting point and the target point by constructing an adjacent node tree connected topology network according to a preset iterative step length, and constructing a candidate path dataset by using all the candidate paths;
S6, establishing a reinforcement learning drive model for the candidate path dataset, and finding a required path by utilizing a target equation with the shortest path and time;
S7, performing high-order curve fitting on the required path to achieve the smoothing of the required path and obtain a final path;
S8, discretizing the final path obtained in step S7, solving and calculating joint angles of the manipulator by using an inverse kinematics algorithm, and determining an angle of each joint of the manipulator to obtain a joint path of each joint moving in a space; and
S9, calculating whether interference exists between each joint path and the obstructed space; when the interference exists between a joint path and the obstructed space, adjusting parameters of the space compression model, and returning to S4 to be re-performed; and when no interference exists between any joint path and the obstructed space, completing path control from the starting point to the target point on the manipulator according to the joint path of each joint moving in the space in S8.

2. The manipulator execution path planning method according to claim 1, wherein S5 specifically comprises:
S51, presetting an iterative step length δ, that is, expanding nodes for a distance δ every time during search;
S52, starting from the starting point, initializing a first node;
S53, searching a new node around the current node according to the preset iterative step length δ; and
S54, connecting the new node to the current node to construct the adjacent node tree connected topology network.

3. The manipulator execution path planning method according to claim 2, wherein S51 further comprises:
presetting a threshold φ, wherein when a distance from the new node to the target point is smaller than or equal to the threshold φ, the target point is considered to be reached, and a cycle step is no longer performed; and a search range is the compressed measurement space Ωₙ.

4. The manipulator execution path planning method according to claim 2, wherein S53 specifically comprises:
S531, supposing that the current node is xₙ(t);
S532, respectively calculating Euclidean distances from all the nodes in the adjacent node tree connected topology network to the current node xₙ(t), selecting the closest node as the closest point x_{f}(t), and backwards extending a new node from x_{f}(t);
S533, determining a new node xₙ(t+1) by calculation, wherein a formula is expressed as:
$${x}_{n} ( t + 1 ) = {x}_{n} ( t ) + δ \cdot \frac{{x}_{r} ( t ) - {x}_{f} ( t )}{\vert {x}_{r} ( t ) - {x}_{f} ( t ) \vert} + \frac{{x}_{g} ( t ) - {x}_{r} ( t )}{\vert {x}_{g} ( t ) - {x}_{r} ( t ) \vert} ;$$
wherein xᵣ(t) is a preselected point possible to become the next node; and
S534, repeating above steps to determine whether a distance from the new node xₙ(t+1) to the target point is smaller than the threshold φ, if so, stopping the repetition; and if not, further performing steps S431 to S434.

5. The manipulator execution path planning method according to claim 1, wherein S7 comprises:
S71, selecting a type and an order of a high-order curve according to complexity, curvature change and smoothness requirements of the required path;
S72, taking a key point or node of the required path as a control point for the high-order curve fitting; and
S73, performing the high-order curve fitting by using the selected type and order of the high-order curve and the control point to generate a curve representing a smoothed path of the required path, i.e., the final path.

6. The manipulator execution path planning method according to claim 1, wherein S8 comprises:
S81, initializing structural parameters of the manipulator, wherein the structural parameters comprise a linkage length, linkage torsion, linkage offset, and the joint angles;
S82, discretizing the final path to form discrete point sequences, wherein the discrete point sequences are taken as path points of motion of the manipulator;
S83, calculating, by using the inverse kinematics algorithm according to the structural parameters and the path points of the manipulator, an angle value required to be reached by each joint, corresponding to each path point, of the manipulator; and
S84, generating a track of change of the angle of each joint of the manipulator with time, i.e., a motion process of the manipulator from the starting point to a target position, according to a result solved by using the inverse kinematics algorithm.
